(19) United States
(12) Patent Application Publication
(10) Pub. No.: US 2014/0134571 A1
(43) Pub. Date: May 15, 2014

(54) Dental Prosthesis And Fabrication

(71) Applicants: Robert Lemke, San Antonio, TX (US); John Marion Tharpe, JR., Albany, GA (US)

(72) Inventors: Robert Lemke, San Antonio, TX (US); John Marion Tharpe, JR., Albany, GA (US)

(21) Appl. No.: 13/676,887

(22) Filed: Nov. 14, 2012

(51) Int. Cl. A61C 8/00

(52) U.S. Cl. CPC A61C 8/0068; A61C 8/0022; A61C 8/0027
USPC 433/174

(57) ABSTRACT

A dental prosthesis apparatus, comprising at least a pair of implants for selective imbedding in maxillary bone structure and each having an angle-adjusting abutments to which a rail clip assembly attaches, each rail clip assembly holding a portion of a rail between a lower rail clip and an upper rail clip, the rail and clip assemblies connected together, for seating of a denture to the abutments. A method of fabricating a dental prosthesis is disclosed.

### TECHNICAL FIELD

The present invention relates to dental prosthesis and fabrication. More particularly, the present invention relates to dental prosthesis readily fabricated chair side of a patient.

### BACKGROUND OF THE INVENTION

In recent years, dental implants have become a viable option for both partial and full prosthesis whereby a missing tooth, or multiple missing teeth, are replaced with an artificial fabricated substitute. There are at least several manufacturers providing dental prosthesis devices. The dental prosthesis technology uses implants that seat in bone structure of the jaw, and a variety of secondary connections referred to as abutments attach rigidly to the implants. Bridges attach to the abutments, and restorative teeth attach in spaced-relation to the bridges.

Generally, a dental surgeon places the implants within bone. The implant location is selected to facilitate acceptance of the implant by bone structure while avoiding weak bone sections, nerves, and sinus cavities. The implants may be disposed at oblique angles in order to seat a longer implant while forming strong implant-to-bone connections. The implants integrate with the bone through bone growth, typically over a several month period. The implants become a foundation that supports the bridges and restorations. An abutment is selected from a variety of abutments having differing characteristics (length, angle, cross-sectional width). The abutment attaches rigidly to the implant for alignment of the bridge.

The abutments are installed upon satisfactory seating of the implant within the bone. Because implant positions are limited to locations of good bone, the abutments provide a gross adjustment of misaligned or off-axis direction of placement of the implant. Multiple implants may be connected together, or splinted, for cross-arch stabilization during the integration process, such as attaching a temporary prosthesis prior to full integration.

A temporary prosthesis, or bridge of teeth, is fabricated for use during integration. The temporary prosthesis is typically made of acrylic, for short term use, as such material is subject to fracture. Thus, temporary prosthesis may not allow for full occlusion whereby the patient may chew food properly.

Upon satisfactory healing of the implant/bone root form, the patient is attended by a prosthodontist for fabrication of a permanent prosthesis. The healing process may be several or more months. With implant/bone integration, an impression is formed of the patient's maxillary structure. The impression is used by a laboratory for fabrication of a rigid framework to support the denture or bridge of teeth. Traditional casting may be used to form the denture, or more recently, digital scanning and CAD/CAM technology may be used. This latter technology features milling a titanium block to form a unique framework. This is specialized machining and there are a limited number of experienced product providers. The labor is time consuming and materials expensive. Once the temporary bridge is replaced with the permanent bridge, the patient is provided with an excellent prosthesis.

However, there are drawbacks limiting the desirability of such permanent prosthesis. Should an implant fail, or move, the milled bar must be completely discarded. The fabrication process recommences with the impression/scanning/milling process repeated. The milled parts are not retrievable for re-use. Generally, the process is time consuming. The time required may span from several months to years for the final permanent prosthesis to be installed. Further, the process requires services of multiple professionals working at various locations remote from each other. As an alternative, a technical company has attempted to shorten the time required by housing the three required professional (surgeon, prosthodontist and dental laboratory technician) in a single complex.

Further, there are drawbacks with these systems for fabrication of prosthesis. The support bars need to be horizontal. Due to positioning variances and angular alignment of the implants, each abutment requires separate height alignment. Further, the abutments require different angular alignment in order to orient the support member vertical for engaging the denture. The present systems further do not readily permit fabrication of the front retaining bar that aligns with the parabolic-shaped dental arch. The rigid assembly of the denture is not removable during fabrication. Also, in the event of moving of the implant, the components used in the denture are lost because of the special design configured for the particular position of the implant. Components are not retrievable and reusable in the event of movement of an implant. Also, the implants provide point-to-point support for the prosthesis and are unsatisfactory for including a cantilever extended portion so as to enlarge the occlusal chewing surface.

Accordingly, there is a need in the art for an improved prosthesis apparatus and method of fabrication. It is to such that the present invention is directed.

### SUMMARY OF THE INVENTION

The present invention meets the need in the art by providing a dental prosthesis apparatus, comprising at least a pair of implants, each implant for selective imbedding in a maxillary bone structure and defining a threaded axial bore, and a pair of abutments, each seated on a respective one of the implants and defining an axial passageway therethrough and defining a second threaded bore therein. A pair of screws, each one extending through the passageway of a respective abutment and engaging the threaded bore of the implant for securing the abutment to the implant. At least a pair of rail assemblies, with each rail assembly attached to a respective one of the abutments. Each rail assembly comprising a spacing member having a threaded first end and defining a longitudinally extending passageway therethrough, a first rail clip disposed at the first end of the spacing member, a second rail clip disposed on a second end of the spacing member, and a fastener connected to the second end of the spacing member for securing the first rail clip and the second rail clip in spaced relation. A threaded member extending through the spacing member and engaging the second threaded bore in the respective abutment for securing the rail assembly to the abutment. A rail extending between the pair of rail assemblies and disposed with a respective portion between the first rail clip and the second rail clip of each of the rail assemblies, whereby the rail assembly, being secured with the threaded member connected to the abutment, rigidly holds the rail between the first rail clip and the second rail clip.

In another aspect, the present invention provides a dental prosthesis apparatus comprising at least a pair of implant members for selective imbedding of each in a maxillary bone structure of a patient. The implant member defines a seating surface to which a respective one of at least a pair of rail assemblies attaches. Each rail assembly comprises a first rail clip and a second rail clip disposed in opposing spaced relation; and a fastener for engaging the seating surface of the implant member and holding the first and second rail clips in spaced relation. A rail extends between the pair of rail assemblies and is disposed with a respective portion between the first rail clip and the second rail clip of each of the rail assemblies. Each of the rail assemblies, being secured with the fastener to the seating surface, rigidly holds the rail between the respective first rail clip and the second rail clip.

In another aspect, the present invention comprises a method of securing a dental prosthesis rail to an implant received in bone, the implant having an abutment secured thereto, the abutment defining a threaded bore therein, comprising the steps of:

(a) providing a lower clip and an opposing upper clip spaced apart by a spacing member and disposing a portion of a rail therebetween;

(b) securing the lower clip and the upper clip together as an assembly to rigidly hold the rail therebetween; and

(c) attaching the assembly of the lower clip and the upper clip to the abutment.

In yet another aspect, the present invention comprises a method of securing a dental prosthesis, comprising the steps of:

(a) imbedding at least a pair of implant members into a maxillary bone structure of a patient in spaced-apart relation, each of the implant members defining a seating surface;

(b) attaching a pair of rail assemblies, each rail assembly attached to a respective one of the implant members, each rail assembly comprising:
a first rail clip and a second rail clip disposed in opposing spaced relation; and
a fastener for engaging the seating surface of the implant member and holding the first and second rail clips in spaced relation;

(c) disposing a rail longitudinally between the pair of rail assemblies with a respective portion between the first rail clip and the second rail clip of each of the rail assemblies,

whereby each of the rail assemblies, being secured with the fastener to the seating surface, rigidly holds the rail between the respective first rail clip and the second rail clip.

Objects, advantages, and features of the present invention will become readily apparent upon a reading of the detailed description in reference to the drawings and the appended claims.

### BRIEF DESCRIPTION OF THE DRAWINGS

FIG. 1 illustrates a full arch assembly of a dental prosthesis in accordance with the present invention.

FIG. 2 is an exploded view of a prosthesis apparatus used in the dental prosthesis illustrated in FIG. 1.

FIG. 3 is a detailed prospective view of an upper rail clip used in the illustrated embodiment of the dental prosthesis shown in FIG. 1.

FIG. 4 is a detailed respective view of a lower rail clip and spacer column used in the illustrated embodiment of the dental prosthesis shown in FIG. 1.

FIG. 5 is a prospective view of a rail member for being received by the lower rail clip and the upper rail clip shown in FIGS. 3 and 4 for the dental prosthesis shown in FIG. 1.

FIG. 6 is a prospective exploded view of an alternate embodiment of a rail for use in a dental prosthesis in accordance with the present invention.

FIG. 7 illustrates a denture molded of a conventional material with a plurality of teeth for containing the prosthesis apparatus illustrated in FIG. 1.

### DETAILED DESCRIPTION

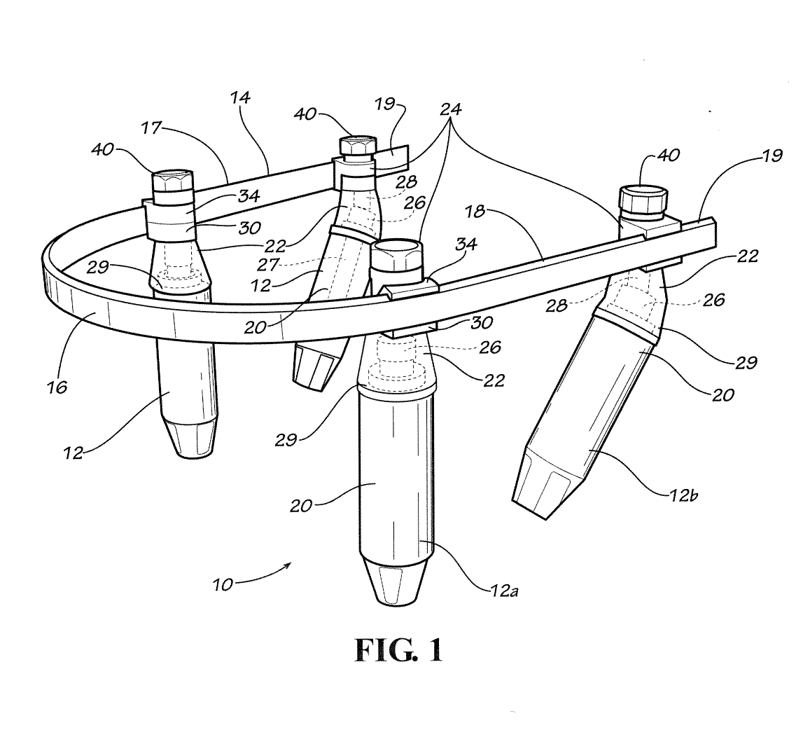

With reference to the drawings, in which like parts have like identifiers, FIG. 1 illustrates a full arch assembly of a dental prosthesis 10 in accordance with the present invention. The prosthesis 10 in the illustrated embodiment includes four implant assemblies 12 and a rail 14 that defines a parabolic-shaped dental arch portion 16 and opposing extending posterior arch portions 17, 18. In the illustrated embodiment, a portion 19 of the rail 14 extends as a cantilever longitudinally posterior of a posterior implant assembly 12b.

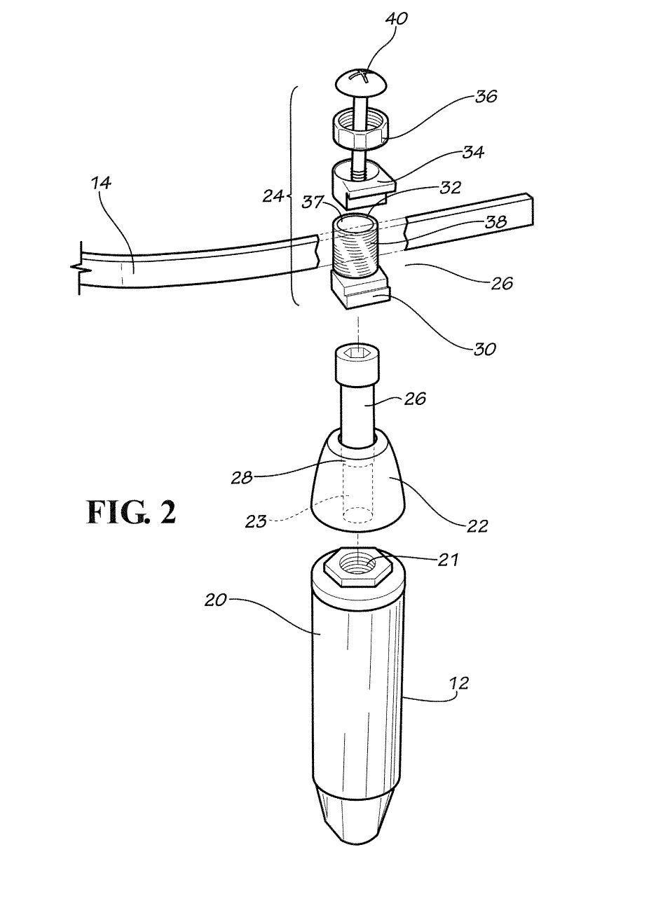

With reference to FIGS. 1 and 2, each implant assembly 12 includes a dental implant 20, an abutment 22, and a clip assembly 24 (shown in detailed exploded view in FIG. 2). The clip assembly 24 secures the rail 14 to the abutment 22 of the implant 20. The implant 20 and the abutment 22 are conventional members provided by dental prosthesis providers. The implant 20 seats in a bone structure of a patient for the dental prosthesis 10. The implant 20 defines an internal threaded bore 21. The abutment 22 defines a first passageway 23. The abutment 22 seats on the upper end of the implant 20. An abutment screw 26 extends through the passageway 23 and threadably engages the threaded bore 21 of the implant 20. The screw 26 thereby secures the abutment 22 to the implant 20.

The abutment 22 further defines a second threaded bore 28. The bore 28 is oriented at an angle within the abutment, so that upon connection of the abutment 22 to the implant, the bore 28 is disposed at a substantially vertical orientation (±5°).

Accordingly, implementation of the present invention provides a plurality of angled abutments 22 (see FIG. 1 and abutments 22a-d) with bores 28 at differing angles, for selective installation. In an alternate embodiment, the abutment 22 defines opposing base surface and seating surface with a threaded bore through the seating surface into the abutment. The base surface is defined at various angles to offset the angle of the installed implant member, so that the seating surface is substantially horizontal for receiving a fastener into the bore at a substantially vertical orientation.

The rail 14 secures with the clip assembly 24 to the abutment 22. The clip assembly 24 includes a lower clip 30, an opposing upper clip 34 and an assembly locking member 36. The rail 14 is held between the lower clip 30 and the upper clip 34, as discussed below. In the illustrated embodiment shown in FIG. 2, each clip assembly 24 further includes a spacer column 32. The spacer column 32 defines an axial passageway 37. In the illustrated embodiment, the spacer column 32 defines a threaded distal end 38. The securing member 36 is a nut threadably received on a threaded distal end 38 of the spacer column 32. A clip assembly screw 40 extends through the nut 36, the open end of the spacer column 32, and through the passageway 37, and engages the threaded bore 28 in the abutment 22. The clip assembly screw 40 attaches the clip assembly 24 to the abutment 22. The angled bore 28 in the abutment 22 provides for gross correction to vertical from the angulation of the implant 20 for receiving the clip assembly 24 that holds the rail 14. The rail 14 is secured between the opposing lower clip 30 and the upper clip 34.

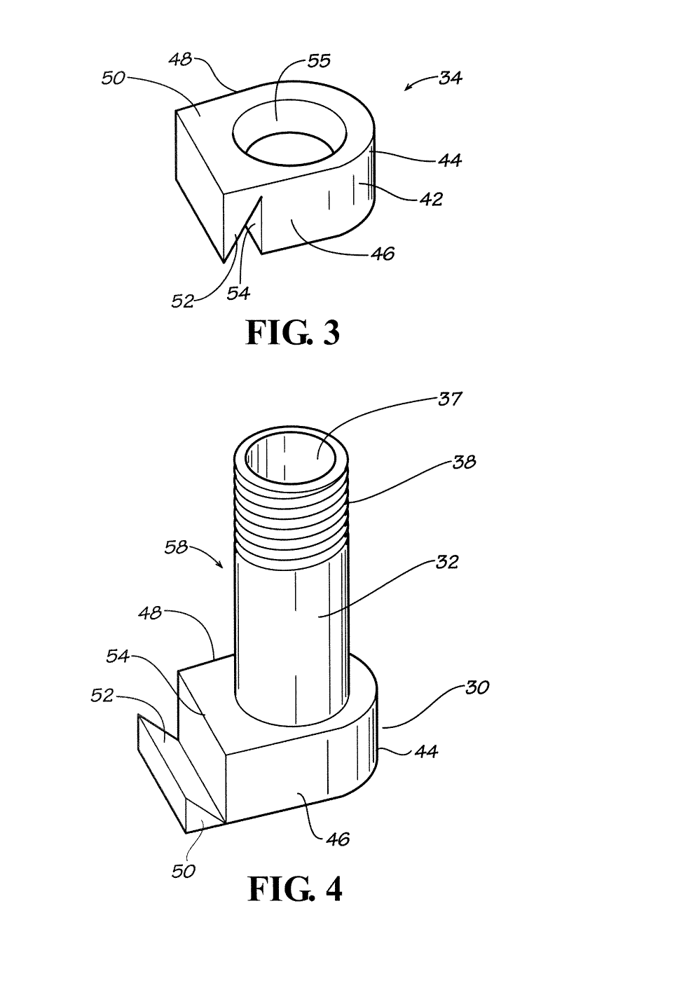

FIG. 3 is a detailed prospective view of an embodiment of the upper clip 34. The upper clip 34 comprises a member 42 having an arcuate wall portion 44 and opposing planar sides 46, 48. A lip 50 extends laterally. The lip 50 is configured for receiving an edge of the rail 14. In the illustrated embodiment, the lip 50 projects laterally from the member 42 and defines a beveled face 52 facing an abutment wall 54. The member 42 defines a through passage 55. The lower clip 30 in one embodiment has the same structure as the upper clip 34. In this embodiment of the clip assembly 34, the spacer column 32 is a separate member received in the passageway of the lower clip 30.

FIG. 4 illustrates an alternate embodiment of the lower clip 30 and the spacer column 32 as a unitary member 58. The spacer column 32 extends from the lower rail clip 30 and defines the through passageway 37. The distal end 38 of the spacer column 32 is threaded. The spacer column 32 is manufactured in selected lengths, so as to position an upper end thereof proximate, or slightly above, the surface of the gum tissue of a patient.

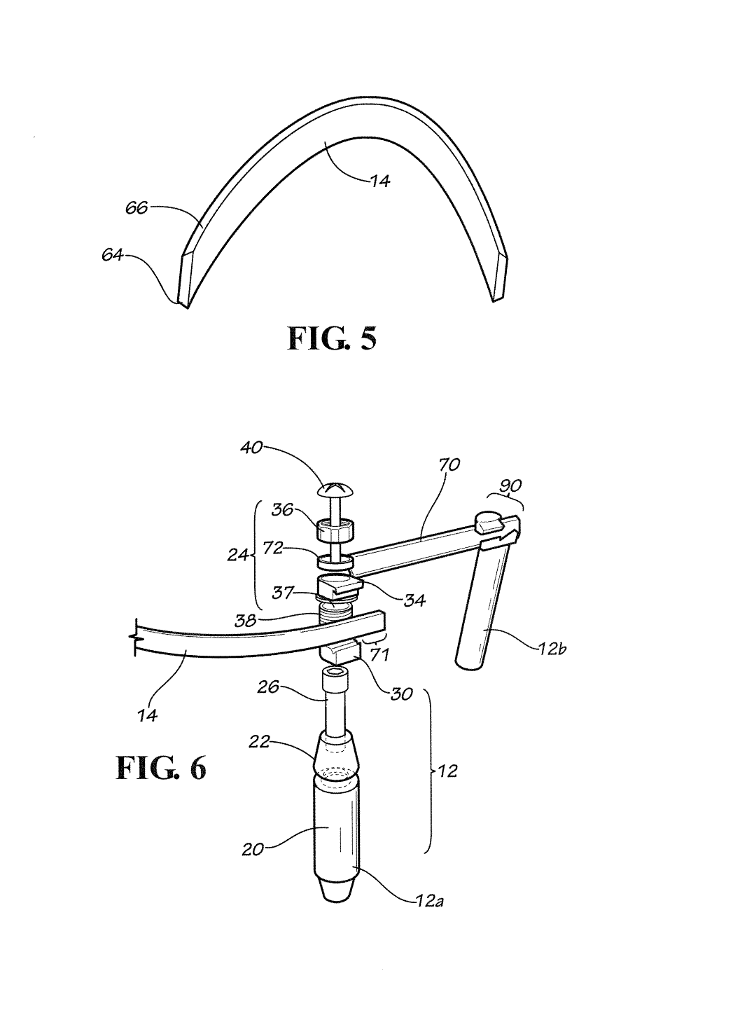

FIG. 5 is a prospective view of the rail 14 for the full arch assembly 10. The rail 14 is an elongated metal band having opposing edges 64, 66. The edges 64, 66 in the illustrated embodiment are beveled for mating contact with the respective beveled surface 52 of the opposing lower and upper clips 30, 34.

With reference to FIG. 2, the securing member 36 or nut threads on the upper end of the spacer column 32. Tightening the nut 36 secures the rail 14 rigidly between the lower clip 30 and the upper clip 34. In an alternate embodiment, a portion of the rail 14 seats on the lower clip 30 and the clip assembly screw 40 secures the upper clip 34, the rail, and the lower clip to the abutment 22.

FIG. 6 is a prospective exploded view of a dental prosthesis using the rail 14 for the anterior dental arch and a posterior rail 70 along the pre-molar and molar region of the arch. The rail 70 extends between an anterior implant assembly 12a and a posterior implant assembly 12b. The rail 14 extends arcuately anterior of the incisors and terminates with a cantilever portion 71 longitudinally beyond the anterior implant assembly 12a. In this embodiment, one end of the rail 70 includes a ring 72. The ring 72 seats on the upper rail clip 34 concentric with the passageway 37 of the clip assembly 34 for the anterior implant assembly 12a. The rail 70 extends to the posterior implant assembly 12b and may also include a posterior cantilever portion 90 thereof.

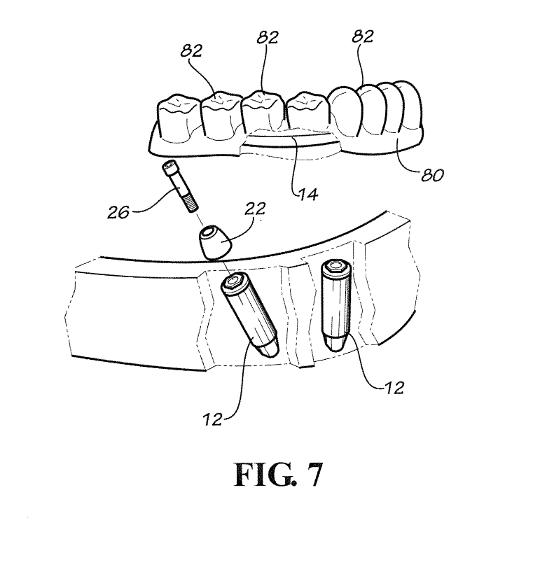

FIG. 7 illustrates a denture 80 molded of a conventional material to which a plurality of teeth 82 attach. The denture 80 defines a U-shape in cross-section for arching over a maxillary or mandibular ridge of a patient. A shown in partial cut-away view, the rail 14 seats within the arch of the denture 80.

With reference to FIG. 1, the dental prosthesis 10 is assembled and installed chair side for a patient. Briefly and in summary, the implant assemblies 12 are selectively positioned in selected locations of the maxillary bone structure of the patient. The denture (pre-configured) is placed in the patient's mouth on the abutments 22 on the respective distil end of the implants 20. Each of the screws 26 extends through a respective abutment 22 and threadedly engages the dental implant 20 to fixedly secure the abutment 22 to the dental implant. The lower clip 30 and spacer column 32 (separate members or unitary) are positioned on the abutment 22. The hollowed out denture 80 is seated over the assemblies 24 and the rail 14. The upper clip 34 is positioned on the threaded end of the clip member 32 so that the beveled surfaces 52 of the lower and upper clips 30, 34 are in opposing facing relation. The nut 36 is loosely threaded on the threaded end 38 of the spacer column 32. The rail 14 seats so that the beveled edges 64, 66 contact the beveled surfaces 52 of the opposing lower clip 30 and upper clip 34. The screws 40 are tightened to secure the clip assemblies to the abutments and hold the rail 14.

In greater detail, the assembly and installation of the dental prosthesis 10 is described below. First, prior to chair side assembly of the dental prosthesis 10 in accordance with the present invention, a conventional denture is made. This involves taking an impression or casting of the patient's maxillary or mandibular ridge that will receive the dental prosthesis 10 as a bridge or replacement denture. As shown in FIG. 1, this may involve a full denture, while an alternate embodiment may use implant assemblies 12 with the rail 14 mounted there between as a bridge along a portion of the dental arch where several teeth may be missing, for example, the incisors portion of mandibular jaw. The denture is fabricated conventionally with porcelain or acrylic teeth embedded in denture material. Further, x-ray, photographic, or digital images are made of the patient's alveolar structure. The oral surgeon analyzes the images of the alveolar bone structure and determines a suitable location and angular orientation of the implant assemblies 12. For example, the upper jaw has a sinus cavity that should be avoided while the lower jaw has nerves that likewise need to be avoided.

The implant assemblies 12 are placed conventionally. This involves drilling pilot holes in the selected location and angle. The process of drilling the pilot holes provides the surgeon with information as to bone density. Angled installation of implants provides longer engagement of the implant with the bone and provides better mechanical stability. Pilot holes may be drilled with successively larger diameters. The implant 20 screws into the drilled hole in the bone structure. The length of the implant 20 is selected so that an upper end of the implant 29 is disposed proximate, at or just below, the soft tissue gingival line of the patient. The abutments 22 are then attached. The abutments 22 correct gross angulation error of the implants 20 in order to provide the substantially vertical orientation of the threaded bore 28 of the abutment. The abutment 22 is selected so as to have an end disposed projecting above the surface of the soft tissue.

The denture is prepared for fitting. An impression material is placed within the open bottom of the denture. The denture is seated on the jaw. The patient then bites down firmly. Each of the abutments 22 makes an indention in the impression material. The denture is removed. The point of contacts of the abutments 22 are drilled through the denture. This creates an opening for access to the abutment. An opening in the denture is made for each implant.

The rail 14 is then adapted to the denture 80. It may be necessary to grind the denture from below to define a channel for the rail 14 within the interior arch of the denture as shown in FIG. 8. With continuing reference to FIGS. 1 and 2, the lower clip 30 with the spacer column 32 is positioned on the abutment 22. The denture is positioned on the alveolar ridge of the patient. This seats the lower edge 64 of the rail 14 on the lower rail clip 30. The beveled edge 64 matingly contacts the beveled face 52 and a side of the rail abuts the wall 54. (It is to be appreciated that in a first embodiment, the lower rail clip 30 and the spacer column 32 are separate members, or as illustrated in FIG. 4 may be an integrated member.)

With access through the opening in the denture, the upper clip 34 seats on the distal end of the spacer column 32. The upper edge 66 similarly matingly engages the beveled face 52 of the upper rail clip 34 and the side of the rail 14 abuts the wall 54. The nut 36 threads on the threaded end 38 of the spacer column 32. The rail 14 is thereby held between the lower clip 30 and the upper clip 34. The assembled clips 30, 34 are loosely held clamping the rail 14 between them. The clip assembly screw 40 extends through the opening formed in the denture and through the nut 36 received on the threaded end of the spacer column 32. The screw 40 extends through the passageway 37 and threadably engages the threaded bore 28 in the abutment 22, to thereby secure the clip assembly 24 to the abutment 22. This step is repeated for each of the at least one other dental implant 20 as would be the case for a bridge having two implants or additional three or more implants for a full arch reconstruction.

A liquid acrylic is poured around the opening in the denture including around the lower clip 30, the upper clip 34 and assembly locking member 36. The liquid acrylic is cured. This holds the rail 14 with the clips 30, 34. The fastener 40 is unthreaded. The assembly of the denture with the rail 14 and the clip assemblies 24 may then be removed as unitary piece. The edges of the denture may then be smoothed to abut the soft tissue of the gingiva over the alveolar ridge. The denture or bridge assembly is replaced in the patient's mouth, and the assembly is secured in place with the clip assembly screws 40. The structure of the rail 14 secured by the clip assemblies 24 to the abutments 22 provides a passive fit for the denture. The rail 14 secured by the clip assemblies does not apply force to the implants 20. The openings in the denture are closed with a curable denture material.

The apparatus and method disclosed herein can be made and executed without undue experimentation in light of the present disclosure. While the apparatus and methods of this invention have been described in terms of illustrative embodiments, it will be apparent to those of skill in the art that variations may be applied to the apparatus and in the method steps or in the sequence of steps thereof described herein without departing from the concept, spirit and scope of the invention. All such similar substitutes and modifications apparent to those skilled in the art are deemed to be within the spirit, scope and concept of the invention as defined by the appended claims.

1. A dental prosthesis apparatus, comprising:
at least a pair of implants, each implant for selective imbedding in a maxillary bone structure and defining a threaded axial bore;
a pair of abutments, each seated on a respective one of the implants and defining an axial passageway therethrough and defining a second threaded bore therein;
a pair of screws, each one extending through the passageway of a respective abutment and engaging the threaded axial bore of the implant for securing the abutment to the implant;
at least a pair of rail assemblies, each rail assembly comprising:
a spacing member having a threaded first end and defining a longitudinally extending passageway therethrough;
a first rail clip disposed at the first end of the spacing member;
a second rail clip disposed on a second end of the spacing member;
a fastener connected to the second end of the spacing member for securing the first rail clip and the second rail clip in spaced relation;
a threaded member extending through the spacing member and engaging the second threaded bore in the respective abutment for securing the rail assembly to the abutment;
a rail extending between the pair of rail assemblies and disposed with a respective portion between the first rail clip and the second rail clip of each of the rail assemblies,
whereby the rail assembly, being secured with the threaded member connected to the abutment, rigidly holds the rail between the first rail clip and the second rail clip.

2. The dental prosthesis as recited in claim 1, wherein a portion of the rail extends longitudinally beyond at least one of the implants as a cantilever.

3. The dental prosthesis as recited in claim 1, further comprising a denture that receives the rail, the denture having plurality of tooth members attached thereto in spaced relation.

4. The dental prosthesis as recited in claim 2, further comprising at least one tooth member attached to a portion of the denture containing the cantilever portion of the rail.

5. The dental prosthesis as recited in claim 1, wherein the rail comprises a planar elongated member.

6. The dental prosthesis as recited in claim 5, wherein the member has opposing side edges that define bevels.

7. The dental prosthesis as recited in claim 1, wherein the lower rail clip defines an angled face and a stop at a distal edge thereof.

8. The dental prosthesis as recited in claim 7, wherein the upper rail clip defines an angled face and a stop at a distal edge thereof.

9. The dental prosthesis as recited in claim 8, wherein the angled faces of the lower rail clip and the upper rail clip member are facing towards each other and the opposing side edges of the rails define bevels and matingly contact the respective angled faces.

10. The dental prosthesis as recited in claim 1, further comprising a second rail having a loop at a first end, the loop received on the spacing member and secured thereto by the nut, and the second rail extending therefrom.

11. A dental prosthesis apparatus, comprising:
at least a pair of implant members, each implant member for selective imbedding in a maxillary bone structure of a patient and defining a seating surface;
at least a pair of rail assemblies, each rail assembly attached to a respective one of the implant members, each rail assembly comprising:
a first rail clip and a second rail clip disposed in opposing spaced relation; and
a fastener for engaging the seating surface of the implant member and holding the first and second rail clips in spaced relation;
a rail extending between the pair of rail assemblies and disposed with a respective portion between the first rail clip and the second rail clip of each of the rail assemblies,
whereby each of the rail assemblies, being secured with the fastener to the seating surface, rigidly holds the rail between the respective first rail clip and the second rail clip.

12. The dental prosthesis apparatus as recited in claim 11, wherein the first and second rail clips have a first spaced relation for the rail to be movable longitudinally therebetween and a second spaced relation for securing the rail fixed from movement therebetween.

13. The dental prosthesis apparatus as recited in claim 11, wherein the seating surface is defined on an abutment, the dental prosthesis apparatus having at least a pair of abutments, each abutment attached to a respective one of the implant members, and each of the abutments having a threaded bore at an angle selected for orienting the bore substantially vertical upon attaching of the abutment to the implant member.

14. The dental prosthesis apparatus as recited in claim 13, wherein the implant member defines a threaded axial bore and the abutment has a passageway for receiving a threaded member for securing the abutment to the implant member.

15. The dental prosthesis apparatus as recited in claim 14, wherein the rail assembly further comprises a spacing member having a through passageway and a threaded end, the first rail clip disposed at an opposing end of the spacing member and the second rail clip received on the opposing end, and a threaded nut received on the threaded end to secure the first rail claim and the second rail clip to the portion of the rail therebetween, the fastener extending through the passageway to secure the rail assembly to the abutment.

16. The dental prosthesis apparatus as recited in claim 15, wherein the first rail clip and the spacing member are unitary.

17. The dental prosthesis apparatus as recited in claim 11, wherein a portion of the rail extends longitudinally beyond at least one of the implants as a cantilever.

18. The dental prosthesis apparatus as recited in claim 11, further comprising a denture that receives the rail, the denture having plurality of tooth members attached thereto in spaced relation.

19. The dental prosthesis apparatus as recited in claim 18, further comprising at least one tooth member attached to a portion of the denture containing the cantilever portion of the rail.

20. The dental prosthesis apparatus as recited in claim 11, wherein the rail comprises a planar elongated member.

21. The dental prosthesis apparatus as recited in claim 20, wherein the member has opposing side edges that define bevels.

22. The dental prosthesis apparatus as recited in claim 21, wherein the first and second rail clips each define an angled face and a stop at a distal edge thereof.

23. The dental prosthesis apparatus as recited in claim 22, wherein the first and second rail clips are disposed with the angled faces towards the opposing rail clip and the opposing side edges of the rails define bevels and matingly contact the respective angled faces.

24. The dental prosthesis apparatus as recited in claim 21, further comprising a second rail having a loop at a first end, the loop receiving the fastening member therethough for securing the first end of the second rail to the respective implant; and further comprising a third implant member and respective rail assembly therefor for securing a second end portion of the second rail.

25. A method of securing a dental prosthesis rail to an implant received in bone, the implant having an abutment secured thereto, the abutment defining a threaded bore therein, comprising the steps of:
(a) providing a lower clip and an opposing upper clip spaced apart by a spacing member and disposing a portion of a rail therebetween;
(b) securing the lower clip and the upper clip together as an assembly to rigidly hold the rail therebetween; and
(c) attaching the assembly of the lower clip and the upper clip to the abutment.

26. A method of securing a dental prosthesis, comprising the steps of:
(a) imbedding at least a pair of implant members into a maxillary bone structure of a patient in spaced-apart relation, each of the implant members defining a seating surface;
(b) attaching a pair of rail assemblies, each rail assembly attached to a respective one of the implant members, each rail assembly comprising:
a first rail clip and a second rail clip disposed in opposing spaced relation; and
a fastener for engaging the seating surface of the implant member and holding the first and second rail clips in spaced relation;
(c) disposing a rail longitudinally between the pair of rail assemblies with a respective portion between the first rail clip and the second rail clip of each of the rail assemblies,
whereby each of the rail assemblies, being secured with the fastener to the seating surface, rigidly holds the rail between the respective first rail clip and the second rail clip.

27. The method as recited in claim 26, wherein the first and second rail clips have a first spaced relation for the rail to be movable longitudinally therebetween and a second spaced relation for securing the rail fixed from movement therebetween.

28. The method as recited in claim 26, wherein the seating surface is defined on an abutment, and further comprising the step of attaching a respective one of at least two abutments to a respective one of the implant members, each of the abutments having a threaded bore at an angle selected for orienting the bore substantially vertical upon attaching of the abutment to the implant member.

29. The method as recited in claim 28, wherein the implant member defines a threaded axial bore and the abutment has a passageway, further comprising the step of receiving a threaded member therethrough for securing the abutment to the implant member.

30. The method as recited in claim 29, wherein the abutment defines a threaded bore therein through the seating surface and further comprising the step of receiving the fastener of the rail assembly in the threaded axial bore.

31. The method as recited in claim 30, wherein the rail assembly further comprises a spacing member having a through passageway and a threaded end, and further comprising the steps of:
disposing the first rail clip at an opposing end of the spacing member and the second rail clip on the opposing end;
passing the rail between the first rail clip and the second rail clip; and
attaching a threaded nut on the threaded end to secure the first rail claim and the second rail clip to the portion of the rail therebetween; and
extending the fastener through the passageway and into the bore to secure the rail assembly to the abutment.

32. The method as recited in claim 31, wherein the step disposing comprises forming the first rail clip and the spacing member as a unitary member.

33. The method as recited in claim 26, wherein a portion of the rail extends longitudinally beyond at least one of the implants as a cantilever.

34. The method as recited in claim 26, further comprising the step of forming a denture that receives the rail, the denture having plurality of tooth members attached thereto in spaced relation.

35. The method as recited in claim 34, further comprising disposing at least one tooth member attached to a portion of the denture containing the cantilever portion of the rail.

36. The method as recited in claim 26, further comprising the step of defining a bevel surface in opposing side edges of the rail.

37. The method as recited in claim 36, wherein the first and second rail clips each define an angled face and a stop at a distal edge thereof, and further comprising the step of disposing the first rail clip and the second rail clip in opposing relation with the angled faces facing towards each other, whereby the beveled surfaces abut the respective angled faces.

38. The method as recited in claim 26, further comprising the steps of providing a second rail having a loop at a first end, extending the fastening member through the loop for securing the first end of the second rail to a respective implant; and providing a third implant member imbedded in bone and having a respective rail assembly therefor for securing a second end portion of the second rail.
